(19) United States
(12) Patent Application Publication
(10) Pub. No.: US 2015/0296479 A1
(43) Pub. Date: Oct. 15, 2015

(54) SYSTEMS, APPARATUS, AND METHODS FOR LOCATION ESTIMATION OF A MOBILE DEVICE

(71) Applicant: QUALCOMM Incorporated, San Diego, CA (US)

(72) Inventors: Hui CHAO, San Jose, CA (US); Yin CHEN, Campbell, CA (US); Payam PAKZAD, Mountain View, CA (US); Andrea CARNEVALI, Santa Clara, CA (US)

(73) Assignee: QUALCOMM Incorporated, San Diego, CA (US)

(21) Appl. No.: 14/253,020

(22) Filed: Apr. 15, 2014

(51) Int. Cl. H04W 64/00; H04W 52/02

(52) U.S. Cl. CPC H04W 64/006; H04W 52/0206; H04W 88/02

(57) ABSTRACT

Systems, apparatus, and methods for estimating the location of a wireless device include determining the location estimate based on accessible access points and without using a received signal strength indicator. In some embodiments, the location estimate is determined based on a center of mass of the accessible access points, a closest accessible access point, a center of mass of N access points, an average angle of the accessible access points, or a Parzen density of accessible access point distributions.

### FIELD OF DISCLOSURE

The disclosure relates to location determination. More particularly, the disclosure relates to estimating the location of a mobile device.

### BACKGROUND

For positioning in a large venue, such as an enclosed structure, it is often desirable to quickly get the first location of a mobile device based on access points (Aps) that the mobile device heard.

A more accurate first location may be critical in deciding which tile of assistance data a mobile device should choose to obtain from the server for a more precise subsequent positioning. Conventional methods use the received signal strength or WiFi signal strength measurements to estimate a location.

Such conventional methods require a significant amount of power during operation. The power drain can be more pronounce the longer the location estimation operation is performed. For example, a user that leaves the conventional location estimation operation running continuously for a long period of time can quickly drain the power in the mobile device.

Accordingly, there are long-felt industry needs for apparatus and methods that improve upon conventional methods including the improved methods and apparatus provided hereby.

The inventive features that are characteristic of the teachings, together with further objects and advantages, are better understood from the detailed description and the accompanying figures. Each of the figures is provided for the purpose of illustration and description only, and does not limit the present teachings.

### SUMMARY

The following presents a simplified summary relating to one or more aspects and/or embodiments associated with the apparatus and methods disclosed herein. As such, the following summary should not be considered an extensive overview relating to all contemplated aspects and/or embodiments, nor should the following summary be regarded to identify key or critical elements relating to all contemplated aspects and/or embodiments or to delineate the scope associated with any particular aspect and/or embodiment. Accordingly, the following summary has the sole purpose to present certain concepts relating to one or more aspects and/or embodiments relating to the apparatus and methods disclosed herein in a simplified form to precede the detailed description presented below.

Exemplary embodiments of the disclosure are directed to systems, apparatus, and methods for estimating a location of a wireless device based on access points.

In some embodiments of the disclosure, the system, apparatus, and method includes a location estimator configured to determine a location estimate of the wireless device based on one of a center of mass of the accessible access points, a closest accessible access point, a center of mass of N access points, an average angle of the accessible access points, and a parzen density of accessible access point distributions.

Other objects and advantages associated with the apparatus and methods disclosed herein will be apparent to those skilled in the art based on the accompanying drawings and detailed description.

### BRIEF DESCRIPTION OF THE DRAWINGS

The accompanying drawings are presented to aid in the description of embodiments of the invention and are provided solely for illustration of the embodiments and not limitation thereof.

A more complete appreciation of aspects of the disclosure and many of the attendant advantages thereof will be readily obtained as the same becomes better understood by reference to the following detailed description when considered in connection with the accompanying drawings which are presented solely for illustration and not limitation of the disclosure, and in which:

FIG. 1 is an exemplary illustration of a location estimate in accordance with some aspects of the disclosure.

FIG. 2 is an exemplary illustration of a location estimate in accordance with some aspects of the disclosure.

FIG. 3 is an exemplary illustration of a location estimate in accordance with some aspects of the disclosure.

FIG. 4 is an exemplary illustration of a location estimate in accordance with some aspects of the disclosure.

FIG. 5 is an exemplary flowchart of a location estimate in accordance with some aspects of the disclosure.

FIG. 6A is an exemplary illustration of a location estimate in accordance with some aspects of the disclosure.

FIG. 6B is an exemplary illustration of a location estimate in accordance with some aspects of the disclosure.

FIG. 7 is an exemplary illustration of a location estimate in accordance with some aspects of the disclosure.

In accordance with common practice, the features depicted by the drawings may not be drawn to scale. Accordingly, the dimensions of the depicted features may be arbitrarily expanded or reduced for clarity. In accordance with common practice, some of the drawings are simplified for clarity. Thus, the drawings may not depict all components of a particular apparatus or method. Further, like reference numerals denote like features throughout the specification and figures.

### DETAILED DESCRIPTION

Various aspects are disclosed in the following description and related drawings to show specific examples relating to exemplary embodiments of the disclosure. Alternate embodiments will be apparent to those skilled in the pertinent art upon reading this disclosure, and may be constructed and practiced without departing from the scope or spirit of the disclosure. Additionally, well-known elements will not be described in detail or may be omitted so as to not obscure the relevant details of the aspects and embodiments disclosed herein.

The word “exemplary” is used herein to mean “serving as an example, instance, or illustration.” Any embodiment described herein as “exemplary” is not necessarily to be construed as preferred or advantageous over other embodiments. Likewise, the term “embodiments” does not require that all embodiments include the discussed feature, advantage or mode of operation. Use of the terms “in one example,” “an example,” “in one feature,” and/or “a feature” in this specification does not necessarily refer to the same feature and/or example. Furthermore, a particular feature and/or structure can be combined with one or more other features and/or structures. Moreover, at least a portion of the apparatus described hereby can be configured to perform at least a portion of a method described hereby.

The terminology used herein is for the purpose of describing particular embodiments only and is not intended to be limiting of embodiments of the invention. As used herein, the singular forms “a,” “an,” and “the” are intended to include the plural forms as well, unless the context clearly indicates otherwise. It will be further understood that the terms “comprises”, “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should be noted that the terms “connected,” “coupled,” or any variant thereof, mean any connection or coupling, either direct or indirect, between elements, and can encompass a presence of an intermediate element between two elements that are “connected” or “coupled” together via the intermediate element. Coupling and/or connection between the elements can be physical, logical, or a combination thereof. As employed herein, elements can be “connected” or “coupled” together, for example, by using one or more wires, cables, and/or printed electrical connections, as well as by using electromagnetic energy. The electromagnetic energy can have wavelengths in the radio frequency region, the microwave region and/or the optical (both visible and invisible) region. These are several non-limiting and non-exhaustive examples.

It should be understood that the term “signal” can include any signal such as a data signal, audio signal, video signal, multimedia signal, analog signal, and/or digital signal. Information and signals can be represented using any of a variety of different technologies and techniques. For example, data, an instruction, a process step, a command, information, a signal, a bit, and/or a symbol described in this description can be represented by a voltage, a current, an electromagnetic wave, a magnetic field and/or particle, an optical field and/or particle, and any combination thereof.

Any reference herein to an element using a designation such as “first,” “second,” and so forth does not limit the quantity and/or order of those elements. Rather, these designations are used as a convenient method of distinguishing between two or more elements and/or instances of an element. Thus, a reference to first and second elements does not mean that only two elements can be employed, or that the first element must necessarily precede the second element. Also, unless stated otherwise, a set of elements can comprise one or more elements. In addition, terminology of the form “at least one of: A, B, or C” used in the description or the claims can be interpreted as “A or B or C or any combination of these elements.”

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

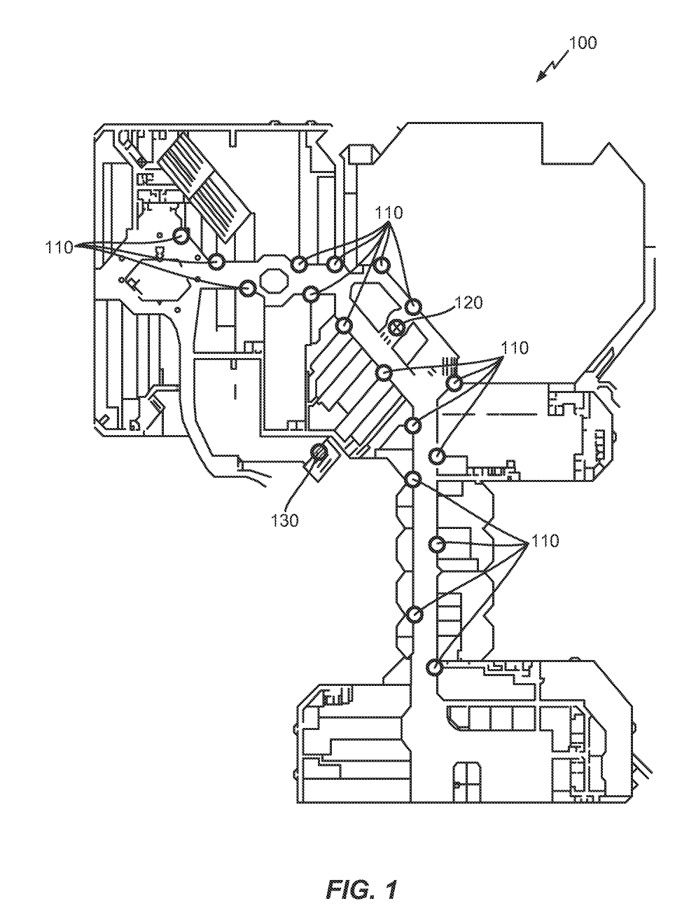

FIG. 1 illustrates an exemplary embodiment of the disclosure. In FIG. 1, a location 100 is depicted. Location 100 has a plurality of access points (APs) 110 accessible by a mobile device 120. The mobile device 120 may receive signals from at least a portion of the plurality of APs 110. In one embodiment, a location estimate 130 is determined using the location of the APs 110. The location estimate 130 is an estimate of the physical location of the mobile device 120. The first location estimate 130, according to some embodiments of the disclosure, is determined using a center of mass calculation for all of the APs 110 accessible by the mobile device 120. The AP location may be downloaded to the mobile device from another location such as a server as initial assistance data (AD) download before deciding on a more detailed AD download. Taking the center of mass for each AP 110, an average center of mass is determined Alternatively, a weighted center of mass calculation can be used with various weighting techniques. This is used as the first location estimate 130 of the mobile device. As shown in FIG. 1, the location estimate 130 is outside or near the perimeter of location 100 and the actual location of mobile device 120 is not very near the estimate. While the discrepancy between the estimate and actual location is important for accuracy reasons, it is more important to estimate the location inside the perimeter of the area of interest. In this case, a building. When the area of interest is concave, a center of mass calculation may result in the location estimate 130 outside the perimeter of location 100.

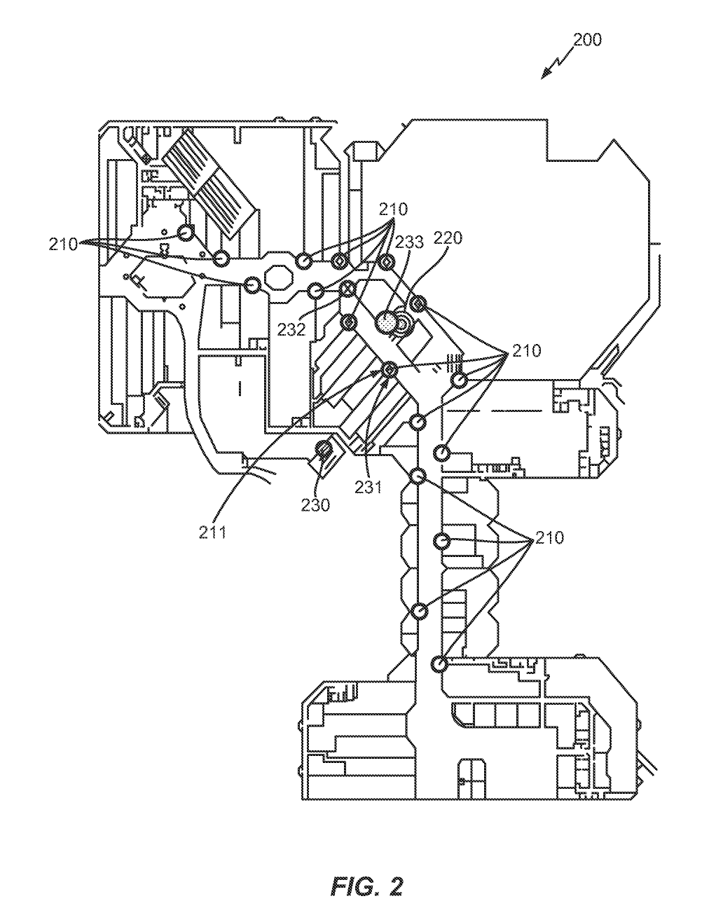

FIG. 2 illustrates an exemplary embodiment of the disclosure. In FIG. 2, a location 200 is depicted. Location 200 has a plurality of access points (APs) 210 accessible by a mobile device 220. The mobile device 220 may receive signals from at least a portion of the plurality of APs 210. In one embodiment, a first step is to identify the type of perimeter for location 200. The type of perimeter is based on the distribution of APs 210. In the first step according to some embodiments of the disclosure, the distribution of APs 210 is identified based on the polygon region obtained from the overlap between the smallest bounding box of all APs and the location 200. If the perimeter is determined to be convex, a first location estimate is determined using the center of mass of the APs 210. If, for example, a center of mass calculation is used on a concave distribution of APs 210 such as shown in FIG. 2, the first location estimate 230 is outside or near the perimeter of location 200 and the actual location of mobile device 220 is not very near the estimate. While the discrepancy between the estimate and actual location is important for accuracy reasons, it is more important to estimate the location inside the perimeter of the area of interest. In this case, a building. When the area of interest is concave, a center of mass calculation may result in the location estimate 230 outside the perimeter of location 200.

If the AP distribution is concave shaped, the location estimate can be determined more accurately by other methods and apparatus described below. For example, a center of mass calculation is used to derive a location estimate 230. Next, the nearest AP 211 to the first location estimate 230 (center of mass for all APs 210) is determined and the location estimate 231 is set as the location of the nearest AP 211. With this approach, the location estimate is within the perimeter of location 200 because the nearest AP 211 is also within the perimeter of location 200.

Alternatively, the location estimate of a concave AP distribution may use a modified iterative center of mass calculation. The first location estimate 230 is determined using a center of mass calculation for all of the Aps 210 accessible by the mobile device 220. Taking the center of mass for each AP 210, an average center of mass is determined (first location estimate 230). Then, select a portion of the nearest APs 210 to the first location estimate 230. For example, the nearest six APs 210 are used for a second center of mass calculation (or weighted center of mass may be used). A third location estimate 232 may be determined by using the center of mass for the six APs 210 nearest to the original center of mass or first location estimate 230 and calculating a revised center of mass for those six APs 210. This location is designated as third location estimate 232.

Alternatively, the location estimate of a concave AP distribution may use a modified iterative center of mass calculation of a polar coordinate system. This approach may minimize collinear situations that result in less than ideal location estimations. First, the first location estimate 230 is determined using a center of mass calculation for all of the Aps 210 accessible by the mobile device 220. Taking the center of mass for each AP 210, an average center of mass is determined (first location estimate 230). This becomes the origin point. Next, all AP locations are transformed from a Cartesian to polar coordinate system based on this origin point. Next, an average angular distribution (theta) of APs 210 is determined Then, select a portion of the APs 210 closest to the average angular distribution. These APs will be used to determine a fourth location estimate 233. For example, the nearest five APs 210 are used for a second calculation (or a weighted calculation may be used). The average location of the nearest five APs 210 is determined. Using this average location, the fourth location estimate 233 may be determined.

Some embodiments of the disclosure determine the shape of the AP distribution by testing whether the first estimated location is outside the perimeter of the location. Some embodiments use an algorithm. For example, if the perimeter is non-convex and the smallest bounding polygon of all the Aps is a non-convex shape, the following methodology may be used. First, the overlap polygon between a bounding box defined by all of the APs and the perimeter is determined To detect a concave polygon, we may apply various algorithms such as the gift wrapping algorithm. This algorithm tests to see if the overlap polygon between the bounding box of the APs and the perimeter is a concave polygon. If so, the distribution of APs should be concave as well.

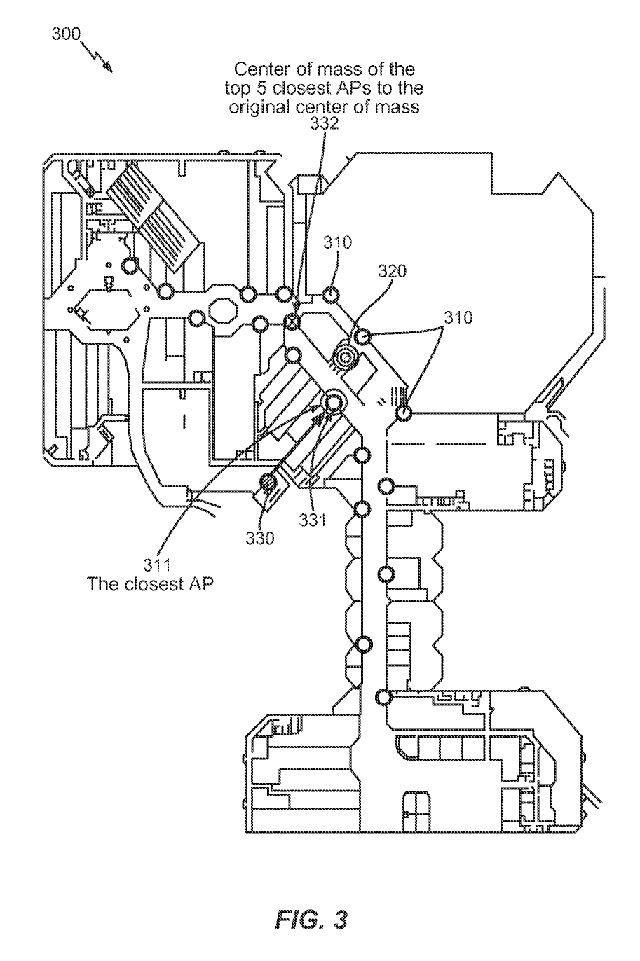

FIG. 3 illustrates some exemplary embodiments of the disclosure. In FIG. 3, a location 300 is depicted. Location 300 has a plurality of access points (APs) 310 accessible by a mobile station 320. The mobile station 320 may receive signals from at least a portion of the plurality of APs 310. In these examples, the type of perimeter for location 300 is concave. The type of perimeter is based on the distribution of APs 310. When the area of interest is concave, a center of mass calculation is first performed using the location information of APs 310. The center of mass calculation is used to derive an initial location estimate 330. Next, the nearest AP 311 to the first location estimate 330 (center of mass for all APs 310) is determined and the location estimate 331 is set as the location of the nearest AP 311. With this approach, the location estimate is within the perimeter of location 300 because the nearest AP 311 is also within the perimeter of location 300.

Alternatively, the location estimate of a concave AP distribution may use a modified iterative center of mass calculation. The first location estimate 330 is determined using a center of mass calculation for all of the APs 310 accessible by the mobile station 320. Taking the center of mass for each AP 310, an average center of mass is determined (initial location estimate 330). Then, select a portion of the nearest APs 310 to the first location estimate 330. For example, the nearest five APs 310 are used for a second center of mass calculation (or weighted center of mass may be used). A location estimate 332 may be determined by using the center of mass for the five APs 310 nearest to the original center of mass or initial location estimate 330 and calculating a revised center of mass for those five APs 310. This location is designated as the location estimate 332.

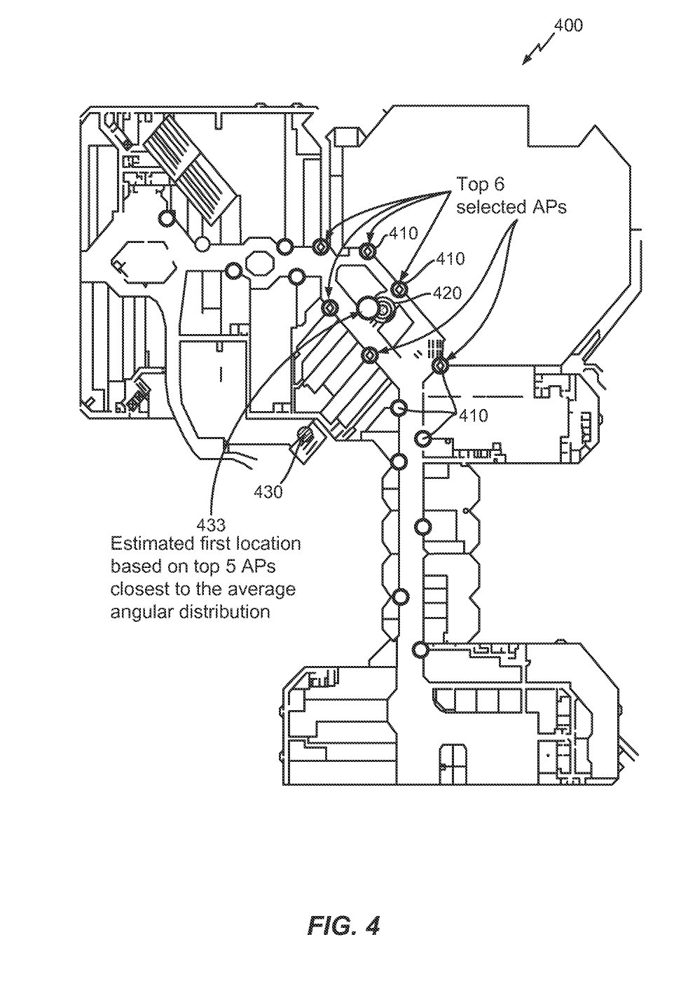

FIG. 4 illustrates some embodiments according to the disclosure. As shown in FIG. 4. the location estimate for a location 400 with a concave AP distribution 410 may use a modified iterative center of mass calculation of a polar coordinate system. This approach may minimize collinear situations that result in less than ideal location estimations. First, the first location estimate 430 is determined using a center of mass calculation for all of the APs 410 accessible by the mobile station 420. Taking the location of each AP 410, an average center of mass is determined (first location estimate 430). This becomes the origin point. Next, all AP 410 locations are transformed from a Cartesian to polar coordinate system based on this origin point. Next, an average angular distribution (theta) of APs 410 is determined Then, select a portion of the APs 410 closest to the average angular distribution. These APs will be used to determine a location estimate 433. For example, the nearest five APs 410 are used for a second calculation (or a weighted calculation may be used). The average location of the nearest five APs 410 is determined Using this average location, the location estimate 433 may be determined or set.

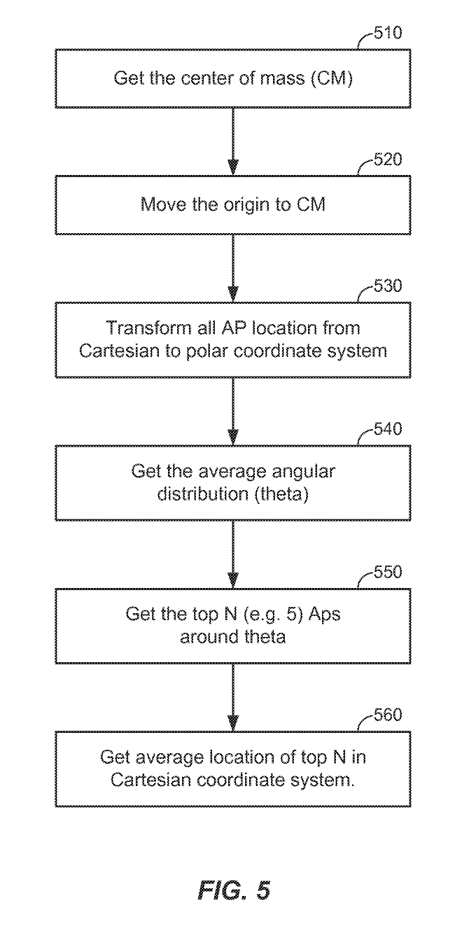

FIG. 5 illustrates some embodiments of the disclosure for estimating a probably location of a mobile wireless station or device. As shown in FIG. 5, step 510 is getting or calculating the center of mass for all APs within range of the mobile station. In step 520, set or move an origin point to the center of mass derived in step 510. In step 530, transform the location information of the APs within range from Cartesian coordinates to polar coordinates using the origin point set in step 520. In step 540, the average angular distribution of the APs is derived or determined In step 550, the top N APs around or N APs closest to the origin point are determined In step 560, the average location of the top N APs in the Cartesian coordinate system is determined. This location will be set as the estimated location of the mobile station.

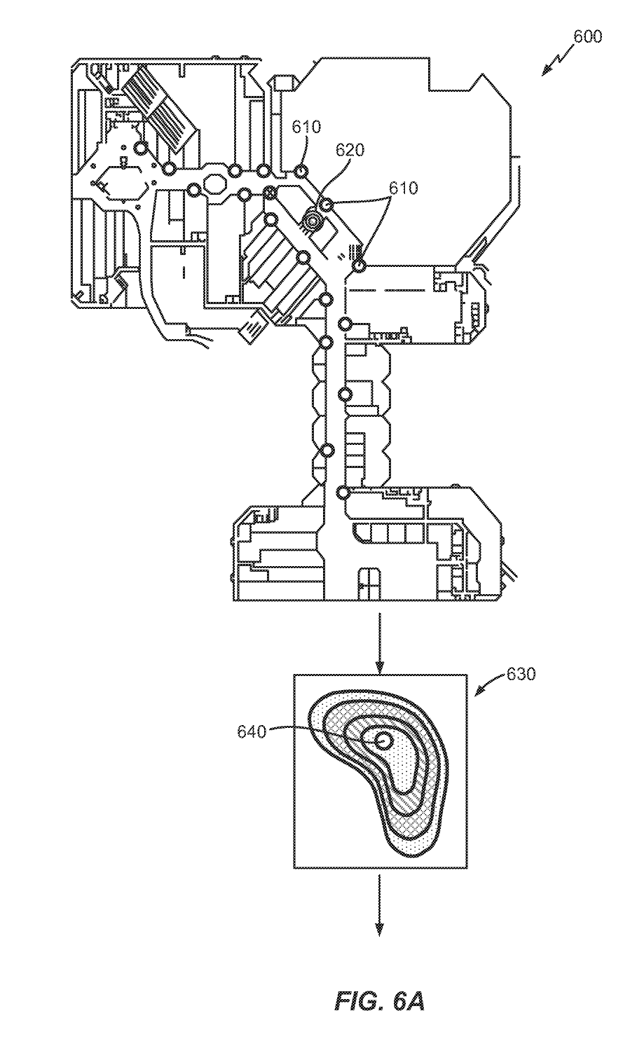

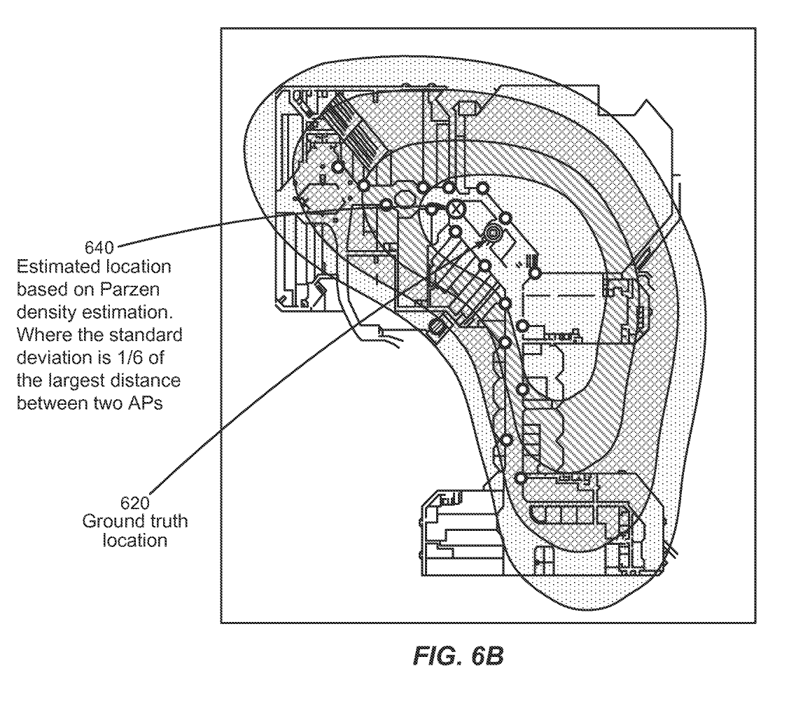

FIG. 6A illustrates some embodiments of the disclosure. In FIG. 6A, a location 600 is depicted. Location 600 has a plurality of access points (APs) 610 accessible by a mobile device 620. The mobile device 620 may receive signals from at least a portion of the plurality of APs 610. First, a Parzen density map 630 is created. The Parzen density map 630 is then used to determine a location estimate 640. As shown in FIG. 6B, the location estimate 640 is based on a maximum of the Parzen density estimation where the standard deviation is ⅙ of the largest distance between two APs 610. The ⅙ sigma is a heuristic value. Other number may be used as a fraction of the largest distance between two APs 610.

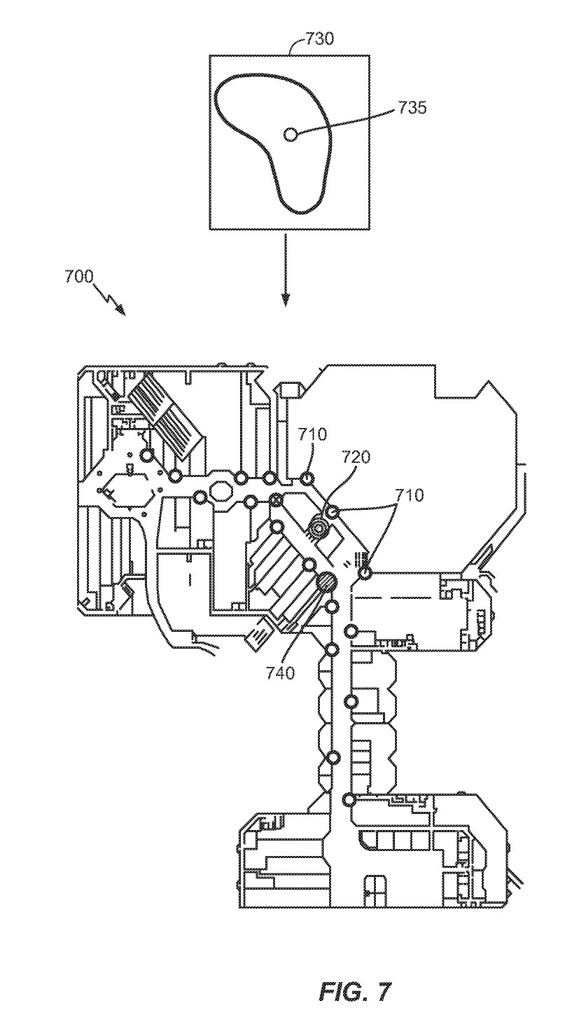

FIG. 7 illustrates some embodiments of the disclosure. In FIG. 7, a location 700 is depicted. Location 700 has a plurality of access points (APs) 710 accessible by a mobile device 720. The mobile device 720 may receive signals from at least a portion of the plurality of APs 710. First, a Parzen density map 730 is created, e.g. by using a sigma equal to ⅙ of the largest distance between two APs 710. The Parzen density map 730 is then used to determine a maximum of the Parzen map. Next, a contour is derived using lines of equal value in the Parzen map, e.g. the contour at half the maximum value. Next, the geodesic center 735 of the contour is determined; this is a point that minimizes the maximum internal distance to any point in the interior of the contour. This location is set as an initial location estimate 740.

Once an initial location estimate is established according to some embodiments of the disclosure, a minimum tile size estimation is made using the N closest APs to the estimated mobile station location. This tile size is used to determine the required amount of assistance data (AD) to be pulled from a server to produce more precise positioning. An accurate initial estimate of location is beneficial and may be critical in determining which tile of assistance data a mobile device should choose to obtain from the server for more precise subsequent positioning. The minimum tile size can be the smallest rectangular bounding box that is centered at the estimated mobile device location and encloses at least N APs, where N can be 3 for example. The size can alternatively or additionally be determined based on a threshold value for the horizontal dilution of precision metric (HDOP), e.g. such that the HDOP value is smaller than 1.5.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

Although some aspects have been described in connection with a device, it goes without saying that these aspects also constitute a description of the corresponding method, and so a block or a component of a device should also be understood as a corresponding method step or as a feature of a method step. Analogously thereto, aspects described in connection with or as a method step also constitute a description of a corresponding block or detail or feature of a corresponding device. Some or all of the method steps can be performed by a hardware apparatus (or using a hardware apparatus), such as, for example, a microprocessor, a programmable computer or an electronic circuit. In some exemplary embodiments, some or a plurality of the most important method steps can be performed by such an apparatus.

The exemplary embodiments described above merely constitute an illustration of the principles of the present disclosure. It goes without saying that modifications and variations of the arrangements and details described herein will become apparent to other persons skilled in the art. Therefore, it is intended that the disclosure be restricted only by the scope of protection of the appended patent claims, rather than by the specific details presented on the basis of the description and the explanation of the exemplary embodiments herein.

In the detailed description above it can be seen that different features are grouped together in exemplary embodiments. This manner of disclosure should not be understood as an intention that the claimed exemplary embodiments require more features than are explicitly mentioned in the respective claim. Rather, the situation is such that inventive content may reside in fewer than all features of an individual exemplary embodiment disclosed. Therefore, the following claims should hereby be deemed to be incorporated in the description, wherein each claim by itself can stand as a separate exemplary embodiment. Although each claim by itself can stand as a separate exemplary embodiment, it should be noted that—although a dependent claim can refer in the claims to a specific combination with one or a plurality of claims—other exemplary embodiments can also encompass or include a combination of said dependent claim with the subject matter of any other dependent claim or a combination of any feature with other dependent and independent claims. Such combinations are proposed herein, unless it is explicitly expressed that a specific combination is not intended. Furthermore, it is also intended that features of a claim can be included in any other independent claim, even if said claim is not directly dependent on the independent claim.

It should furthermore be noted that methods disclosed in the description or in the claims can be implemented by a device comprising means for performing the respective steps or actions of this method.

Furthermore, in some exemplary embodiments, an individual step/action can be subdivided into a plurality of sub-steps or contain a plurality of sub-steps. Such sub-steps can be contained in the disclosure of the individual step and be part of the disclosure of the individual step.

Accordingly, an embodiment of the disclosure can include a computer readable media embodying a method for location estimation. Accordingly, the disclosure is not limited to illustrated examples and any means for performing the functionality described herein are included in embodiments of the disclosure.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

What is claimed is:

1. A method of low power estimation of a location of a wireless device based on accessible access points within a perimeter, comprising the steps of:
determining a location estimate of the wireless device based on one of a center of mass of the accessible access points, a closest accessible access point, a center of mass of N access points, an average angle of the accessible access points, and a Parzen density of an accessible access point distribution.

2. The method of claim 1, further comprising:
determining a tile size for assistance data based on the determined location estimate of the wireless device.

3. The method of claim 1, further comprising determining the location estimate without a received signal strength indicator.

4. The method of claim 1, wherein N is 5.

5. The method of claim 1, further comprising determining a distribution of the accessible access points, wherein the distribution is one of convex and concave.

6. The method of claim 5, further comprising
upon determining the distribution is concave, determining the location estimate of the wireless device based on an average angle of the accessible access points.

7. The method of claim 6, wherein determining the location estimate based on the average angle of the accessible access points comprises:
determine an origin location of the center mass of the accessible access points;
transform a location of each accessible access point from a Cartesian coordinate system to a polar coordinate system based on the determined origin location;
determine an average angular distribution of the accessible access points;
determine N closest access points based each accessible access point angular distribution and the center of mass of the accessible access points; and
determine an average location of the N closest access points.

8. The method of claim 1, wherein determining the location estimate of the wireless device based on the Parzen density of the accessible access points distribution comprises:
determine a maximum of the Parzen density with a sigma;
determine a contour of half the maximum value; and
determine a geodesic center of the contour.

9. The method of claim 8, wherein with the sigma is approximately equal to ⅙ a longest distance between any two accessible access points.

10. An apparatus for estimating a location of a wireless device based on access points, comprising:
a location estimator configured to determine a location estimate of the wireless device based on one of the center of mass of the accessible access points, a closest accessible access point, a center of mass of N access points, an average angle of the accessible access points, and a Parzen density of accessible access point distributions; and
a tile size estimator configured to determine a tile size for assistance data based on the determined location estimate of the wireless device.

11. The apparatus of claim 10, further comprising a classifier configure to determine a distribution of the accessible access points, wherein the distribution is one of convex and concave.

12. The apparatus of claim 10, wherein N is 5.

13. The apparatus of claim 10, wherein the location estimator determines the location estimate without accessing a received signal strength indicator.

14. The apparatus of claim 10, wherein the location estimator is located in a mobile station.

15. A non-transitory computer-readable medium comprising code for causing a computer to:
determine a location estimate of a wireless device based on one of a center of mass of the accessible access points, a closest accessible access point, a center of mass of N access points, an average angle of the accessible access points, and a Parzen density of an accessible access point distribution.

16. The non-transitory computer-readable medium of claim 15, wherein the code further causes the computer to determine a distribution of the accessible access points, wherein the distribution is one of convex and concave.

17. The non-transitory computer-readable medium of claim 15, wherein the code further causes the computer to determine a tile size for assistance data based on the determined location estimate of the wireless device.

18. The non-transitory computer-readable medium of claim 15, wherein the code further causes the computer to determine the location estimate without a received signal strength indicator.

19. The non-transitory computer-readable medium of claim 15, wherein N is 5.

20. The non-transitory computer-readable medium of claim 15, wherein the code further causes the computer to, upon determining the distribution is concave, determine the location estimate of the wireless device based on an average angle of the accessible access points.

21. The non-transitory computer-readable medium of claim 15, wherein the code further causes the computer to:
determine an origin location of the center mass of the accessible access points;
transform a location of each accessible access point from a Cartesian coordinate system to a polar coordinate system based on the determined origin location;
determine an average angular distribution of the accessible access points;
determine N closest access points based each accessible access point angular distribution and the center of mass of the accessible access points; and
determine an average location of the N closest access points.

22. The non-transitory computer-readable medium of claim 15, wherein the code further causes the computer to:
determine a maximum of the Parzen density with a sigma;
determine a contour of half the maximum; and
determine a geodesic center of the contour.

23. The non-transitory computer-readable medium of claim 22, wherein the sigma is approximately equal to ⅙ a longest distance between any two accessible access points.
